(19) United States
(12) Patent Application Publication
(10) Pub. No.: US 2023/0390965 A1
(43) Pub. Date: Dec. 7, 2023

(54) AN ELEMENT FOR A CO-ROTATING TWIN-SCREW PROCESSOR

(71) Applicant: STEER ENGINEERING PRIVATE LIMITED, Bengaluru (IN)

(72) Inventor: BABU PADMANABHAN, Bengaluru (IN)

(73) Assignee: STEER ENGINEERING PRIVATE LIMITED, Bengaluru (IN)

(21) Appl. No.: 18/032,175

(22) PCT Filed: Oct. 1, 2021
(86) PCT No.: PCT/IB2021/059031

§ 371 Date: Apr. 15, 2023

(30) Foreign Application Priority Data
Oct. 15, 2020 (IN) 202041044894

(51) Int. Cl. B29B 7/48

(52) U.S. Cl. CPC B29B 7/489; B29B 7/481

(57) ABSTRACT

An element for a co-rotating twin screw processor, the element having an axial bore for mounting on a screw shaft of the processor, the element comprising a continuous self-wiping flight helically formed thereon, the element comprising a plurality of segments, wherein the flight has a different lead in at least two segments of the plurality of segments.

### FIELD OF INVENTION

The present disclosure relates the field of twin-screw processors. More particularly, the disclosure relates to an element for a co-rotating twin-screw processor.

### BACKGROUND OF THE INVENTION

Co-rotating twin screw processors, such as a twin screw extruder, are typically used in production, compounding, and processing of materials such as plastics, food, paint and pharmaceuticals. A primary task carried out by the twin screw processor is mixing of the materials to produce a melt. Melting and homogenizing of the materials in a twin screw processor involves application of forces that cause shearing, smearing, elongation, bending, torsion, and compression. Generally, a progress of the materials through the twin screw processor is also controlled at every step of the melting and homogenizing process by the selective use of specific processor elements. The twin screw processors may include different processing elements mounted on screw shafts that allow the twin screw processors to be adapted to different processing requirements.

Elements may be self-wiping or non self-wiping, where a self-wiping element wipes or cleans the corresponding element on the other shaft when the elements are rotated in the same direction. Each element has a flight formed thereon that extends along the length of the element and comprises of raised portions or lobes having larger radial diameter than the root diameter of the element. The number of lobes may be an integer or a non-integer forming integer lobe or non-integer lobe flights respectively.

U.S. Pat. No. 6,783,270 to Babu, discloses fractional lobe elements. U.S. Pat. No. 10,207,423B2 to Babu discloses an element comprising a continuous flight, having a lead L, that transforms from an integer lobe flight to a non-integer lobe flight and back to an integer lobe flight over a fraction of the lead L of the element. Further, U.S. Pat. No. 10,239,233B2 discloses an element comprising a continuous flight, having a lead L, that transforms from a first non-integer lobe flight to a second non-integer lobe flight and back to the first non-integer lobe flight over a fraction of the lead L of the element.

There remains a need for elements for a co-rotating processor that offer better control on the mixing capabilities of the processor. There is also a need for elements that permit lower temperature processing of material.

### SUMMARY OF THE INVENTION

In an aspect of the disclosure, an element for a co-rotating twin screw processor having an axial bore for mounting on a screw shaft of the processor is disclosed. The element comprises a continuous self-wiping flight helically formed thereon. Further, the element comprises multiple segments and the flight has a different lead in two or more segments of the multiple segments.

### BRIEF DESCRIPTION OF DRAWINGS

The accompanying drawings, similar reference numerals, may refer to identical or functionally similar elements. These reference numerals are used in the detailed description to illustrate various embodiments and to explain various aspects and advantages of the present disclosure.

FIG. 1 is an exemplary illustration of a co-rotating twin screw processor in accordance with an embodiment of the present disclosure;

FIG. 2 is a top view of processing elements in the co-rotating twin screw processor of FIG. 1, in accordance with the embodiment of the present disclosure;

FIG. 3 is a front view of a processing element of FIGS. 1-2, in accordance with the embodiment of the present disclosure;

FIG. 4 is a schematic block diagram of the processing element of FIG. 2 having multiple segments with different leads respectively, in accordance with a first embodiment of the present disclosure;

FIG. 5 is a schematic block diagram of the processing element of FIG. 2 having multiple segments with different leads, in accordance with a second embodiment of the present disclosure;

FIG. 6 is a schematic block diagram of the processing element of FIG. 2 having multiple segments with equal lengths respectively, in accordance with the embodiments of the present disclosure;

FIG. 7 is a schematic block diagram of the processing element of FIG. 2 having multiple segments with different lengths respectively, in accordance with the embodiments of the present disclosure;

FIG. 8 is a schematic block diagram of the processing element of FIG. 2 having multiple segments with different flight transformations, in accordance with the embodiments of the present disclosure;

FIGS. 9-12 is a schematic block diagram of two adjacent segments of the multiple segments of FIGS. 4-8, in accordance with the embodiments of the present disclosure;

FIGS. 13-16 is a schematic block diagram of a segment of the multiple segments of FIGS. 4-8, in accordance with the embodiments of the present disclosure; and

FIG. 17 is an exemplary illustration of a processing element of FIG. 2 having multiple segments, in accordance with a third embodiment of the present disclosure.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various embodiments of the present disclosure.

### DETAILED DESCRIPTION

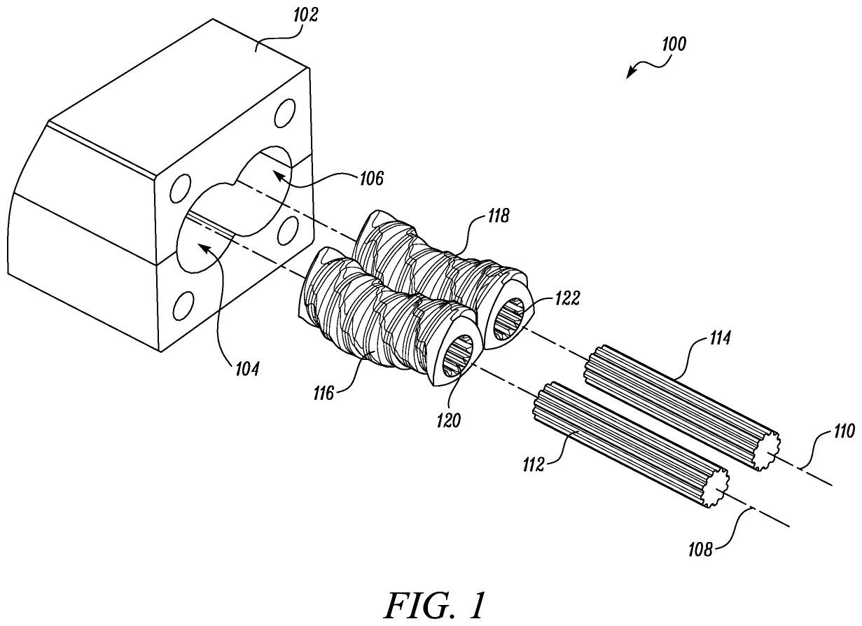

Referring to FIG. 1, an exemplary illustration of a co-rotating twin screw processor 100, herein referred to as “processor 100” is disclosed. The processor 100 may comprise a housing 102 having two cylindrical housing bores 104, 106. The two cylindrical housing bores 104, 106 may have an axis 108 and 110 respectively disposed parallelly with respect to each other. A first screw shaft 112 and a second screw shaft 114 are disposed in the first and second housing bores 104, 106 respectively. A pair of processing elements 116, 118 or ‘elements’ may be mounted on the screw shafts 112, 114 respectively. In an embodiment, a plurality of such element pairs mounted on respective screw shafts may define the various zones within the processor 100 including the intake zone, the mixing zone and the output zone. The elements 116, 118 may comprise grooved axial bores 120, 122 in which splines of the screw shafts 112, 114 respectively are engaged. It may be apparent that the elements 116, 118 may also be configured for mounting on the screw shafts 112, 114 via different engagement means.

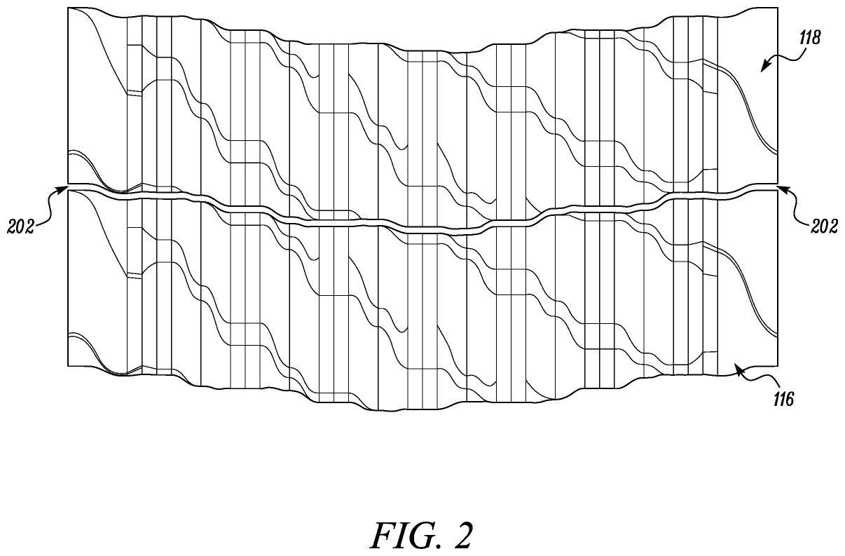

Referring to FIG. 2, an exemplary illustration of a top view of the elements 116, 118 of FIG. 1 is provided. The elements 116, 118 in accordance with an embodiment of the disclosure are fully self-wiping or self-cleaning such that, the element 116 effects a complete wiping of the element 118 when the elements 116, 118 are co-rotated simultaneously. A minimum specified clearance 202 is defined between the elements 116, 118 so as to allow the elements 116, 118 to be self-wiping. Fully wiping elements and how they are generated are described for example in the book by Klemens Kohlgruber—The co-rotating twin screw extruder. The screw profile or flight on one element determines the screw profile on the second element, and are accordingly referred to as a generating screw profile and a generated screw profile respectively. For purposes of clarity and understanding, one element 116 will be described in detail.

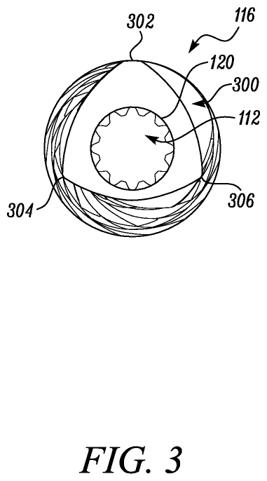

Referring to FIG. 3, a front view of the element 116 of FIGS. 1-2 having the axial bore 120 that is engaged with the screw shaft 112 is disclosed. The element 116 comprises a continuous self-wiping flight 300, helically formed thereon. The flight 300 may have one or more lobes or non-integer lobes, such as, fractional lobes 302, 304, 306, along a length of the element 116. The flight 300 may have an integer number of lobes or a non-integer number of lobes, such as a fractional lobe or irrational lobe, or any combination thereof, along the length of the element 116 that form the flight 300. The flight 300 formed is continuous without any breaks or interruptions. The number of lobes has conventionally been an integer and typically varies between one to four lobes. Such elements are referred to as “integer lobe flight” in this disclosure. The number of lobes may also be a non-integer and such elements are referred to as “non-integer lobe flight” or elements having a non-integer lobe flight.

A non-integer lobe element may be a fractional lobed element. Examples of a fractional lobe element formed from a single lobe element, a bi-lobe element, a tri-lobe element, and/or a four lobe element are described in U.S. Pat. Nos. 6,783,270, 10,207,423, and 10,239,233. A non-integer lobe element may be an irrational number lobed element. Irrational number lobed elements are described in U.S. Pat. No. 8,753,003. A fractional lobed element is an element intermediate a first integer element (n) and a second integer element (N) by a predefined fraction, such that N/n is an integer and the fraction determines the degree of transition between the first integer and the second integer. A single flight lobe and a bi-lobe can form fractional lobes such as 1.2.xx, where xx can be any number from 1 to 99. The numbers 1 to 99 define whether the fractional lobe will look more like a single flight element or a bi-lobed element. The numbers 1 and 2 in the notation 1.2.xx represent the lobe element intermediate a single flight element (1) and a bi-lobe element respectively (2). Thus a fractional lobe element represented as 1.4.50 represents an element mid-way between a single flight and a four lobe element.

In an embodiment, the flight 300 may start as an integer or non-integer number of lobes. For example, in FIG. 3 the flight 300 starts as a fractional lobe flight, designated by 1.3.05, corresponding to a fractional lobe flight between a single lobe and a tri lobe flight.

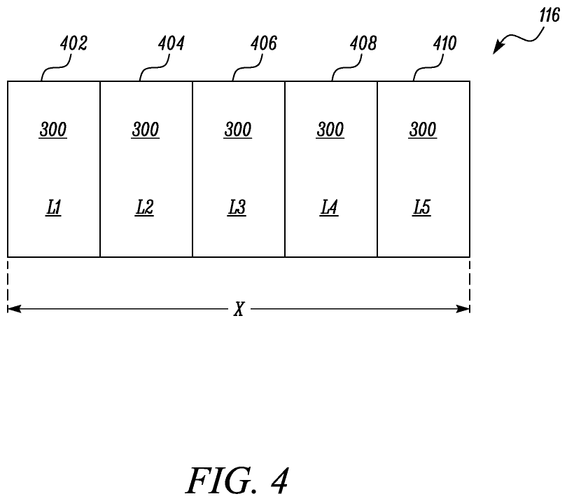

Referring to FIG. 4, the element 116 may also comprise multiple segments 402-410 along the length X of the element 116. The length X of the element 116 may be in a range of 10 mm-200 mm, but smaller or larger element lengths are not intended to be excluded. The flight 300 of the element 116 may have a different lead in two or more segments of the segments 402-410. For example, the flight 300 in the segments 402-410 may have leads L1-L5 respectively with at least two of the leads from L1 to L5 being different from each other with one of the leads being larger than the other. In an embodiment, all adjacent segments of the segments 402-410 have different leads. In an embodiment, at least two adjacent segments of the segments 402-410 have different leads. In an embodiment, each of the segments may have a different lead L1 to L5.

For example, the flight 300 may have a different lead L1-L5 in every segment of the segments 402-410 respectively as shown. Accordingly, the flight 300 may have a different lead in two or more adjacent segments of the segments 402-410 as shown. For example, the flight 300 in segment 402 may have the lead L1 and the flight 300 in segment 404, adjacent to segment 402, may have a different lead L2. Similarly, the flight 300 in segment 406 may have the lead L3 and the flight 300 in segment 408, adjacent to segment 406, may have a different lead L4.

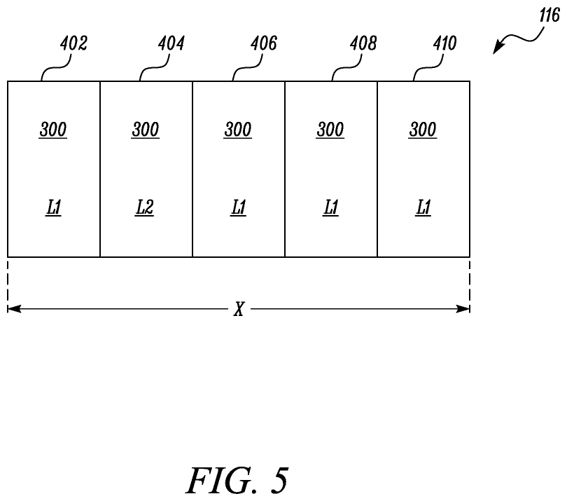

Referring to FIG. 5, in another embodiment, the flight 300 may have a same lead in two or more adjacent segments of the segments 402-410. For example, the flight 300, while having a different lead in segments 402 and 404, has the same lead L1 in the segments 406-410.

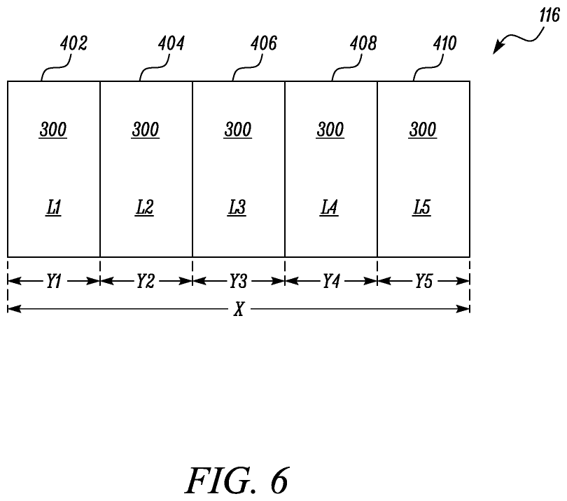

Referring to FIG. 6, in one embodiment, lengths Y1-Y5 of the segments 402-410 respectively of the element 116 may be equal with respect to each other.

In other embodiments, the length of at least two segments may be different. In other embodiments, the length of each segment may be different.

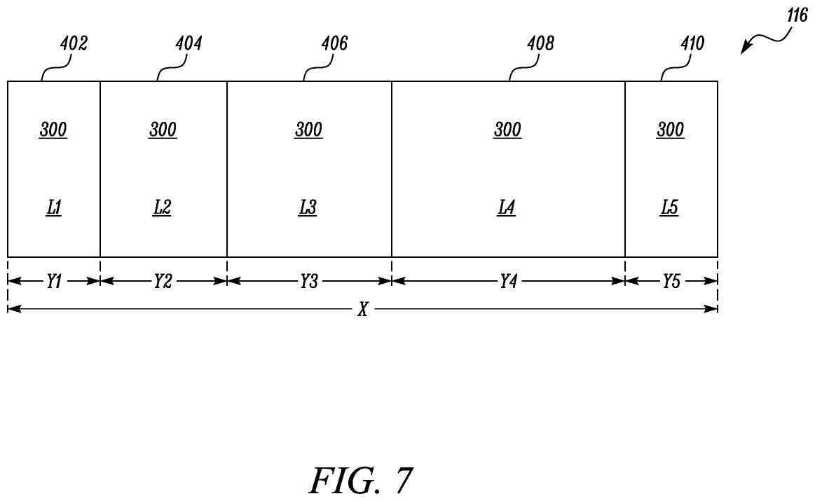

Referring FIG. 7, the lengths Y1-Y5 of the segments 402-410 may be different with respect to each other. For example, the lengths Y1-Y5 of the segments 402-410 may be 2 mm, 0.5 mm, 0.5 mm, 0.5 mm, and 1 mm respectively.

The lengths Y1-Y5 of the segments 402-410 respectively, as shown in FIGS. 6-7, may be in a range of 2 percent to 20 percent of the length X of the element 116, but not limited to the range specified herein. For example, the length X of the element 116 may be 25 mm and the lengths Y1-Y5 of the segments 402-410 may be in a range of 0.5 mm-5 mm respectively.

Referring to FIGS. 3-7, in an embodiment, the flight 300 may be an integer lobe flight or a non-integer lobe flight, such as a fractional lobe flight or an irrational lobe flight, throughout the length X of the element 116. For example, the flight 300 of the element 116 may be a fractional lobe flight, designated by 1.3.xx, in all the segments 402-410 with no change in the lobes throughout the length X of the element 116.

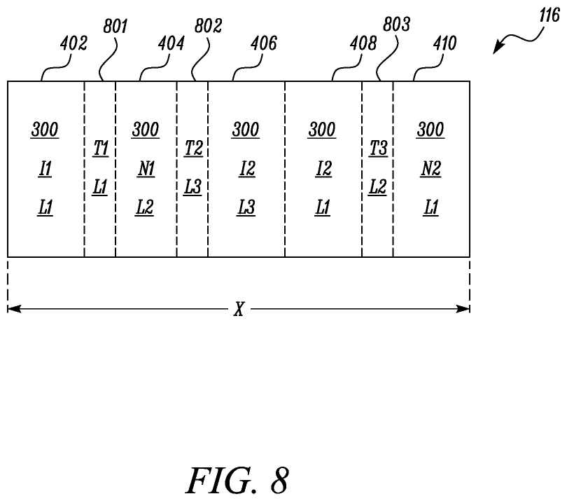

Referring to FIG. 8, in another embodiment, the transformation of the flight 300 in the segments 402-410 respectively, may involve a change in the lobes. For example, the flight 300 may transform in the segments 402-410 between an integer lobe flight and a non-integer lobe flight such as a fractional lobe flight or an irrational lobe flight. In accordance with an embodiment, the flight 300 may first transform into a transition flight before a transformation involving the change in lobes. For example, the flight 300 may transform into a transition flight between transformations from an integer lobe flight to a non-integer lobe flight or vice versa, or also from an integer lobe flight to another integer lobe flight or from a non-integer lobe flight to another non-integer lobe flight. The transitional flight corresponds to a transition intermediate between different integer to integer, integer to non-integer, non-integer to integer, or non-integer to non-integer lobe flight transformations of the flight 300 in the segments 402-410 respectively

For example, in an embodiment, the flight 300 in the segment 402, may be a first integer lobe flight Il. The flight 300 may first transform into a transition flight T1 in a transition segment 801 and then transform to a first non-integer lobe flight N1 in the segment 404. The transition flight T1 may be an intermediate flight between the first integer lobe flight Il in segment 402 and first non-integer lobe flight N1 in the segment 404.

A lead of the flight 300 in a transition segment may be the same as the previous or following segment or different. For example, the transition flight T1 in the transition segment 801 may have the same lead L1 as the previous segment 402 as shown or a different lead, such as L2 or L3, from the segment 402. The lead of the flight 300 in different transition segments may also be the same or different with respect to each other. For example, the lead of flight 300 in the transition segments 801-803 may be the same lead L1 or may have different leads L1, L3, L2 respectively as shown.

Similarly, the flight 300 in the segment 404 may transform back to the first integer lobe flight Il or transform into a second integer lobe flight I2 in the segment 406 from the transition flight T2 in the transition segment 802, as shown. By way of example, the first integer lobe flight may be a bi-lobe and the second integer lobe flight may be a tri-lobe. The flight 300 may continue to be a second integer lobe flight I2 in segment 408 as shown or may transform into another integer lobe flight or a different non-integer lobe flight. Illustratively, the flight 300 in the next segment 410 may transform into a second non-integer lobe flight N2 from the transition flight T3 in the transition segment 803.

In one embodiment, the flight 300 in the segments 402-410 may have a different lead and a different integer lobe in two or more segments of the segments 402-410. In an embodiment each segment of the plurality of segments 402-410 would have a different lead and a different integer lobe flight. Each such transition would be through intermediate transition segments, such as the transition segments 801-803, where the flight 300 transforms into a transition flight, such as the transition flights T1-T3.

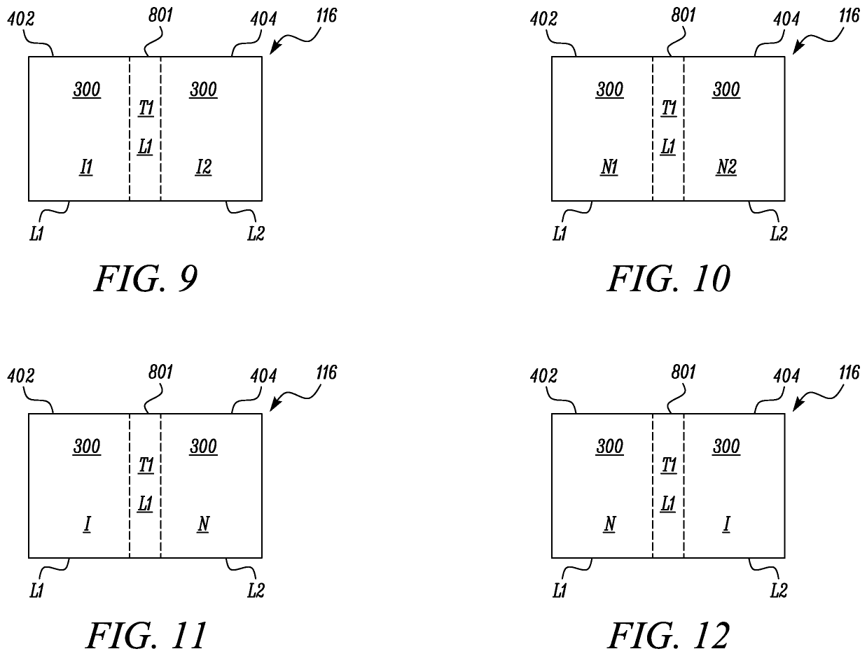

Referring to FIG. 9, the flight 300 in segment 402 with the lead L1 may transform from the first integer lobe flight Il to the transition flight T1 in the transition segment 801 and then transform to the second integer lobe flight I2 in segment 404 with lead L2.

In another embodiment, the flight 300 may have a different lead and a different non-integer lobe in two or more segments of the segments 402-410. In an embodiment each segment of the plurality of segments 402-410 would have a different lead and a different non-integer lobe flight. Each such transition would be through intermediate transition segments where the flight 300 transforms into a transition flight.

Referring to FIG. 10, the flight 300 in segment 402 with lead L1 may transform from the first non-integer lobe flight N1 to the transition flight T1 in transition segment 801 and then transform into the second non-integer lobe flight N2 in segment 404 with lead L2. By way of example, the first non-integer lobe flight may be a 1:3:50 fractional lobe flight and the second non-integer lobe flight may be a 1:2:40 fractional lobe flight.

In yet another embodiment, the flight 300 may have a different lead in adjacent segments of the segments 402-410 and the flight 300 may transform from an integer lobe flight to a non-integer lobe flight in the adjacent segments.

Referring to FIG. 11, the flight 300 in segment 402 with lead L1, may transform from the integer lobe flight I to the transition flight T1 in transition segment 801 and then transform into the non-integer lobe flight N in segment 404 with lead L2.

Referring to FIG. 12, the flight 300 in segment 402 with lead L1, may transform from the non-integer lobe flight N to the transition flight T1 in transition segment 801 and then transform into the integer lobe flight I in segment 404 with lead L2.

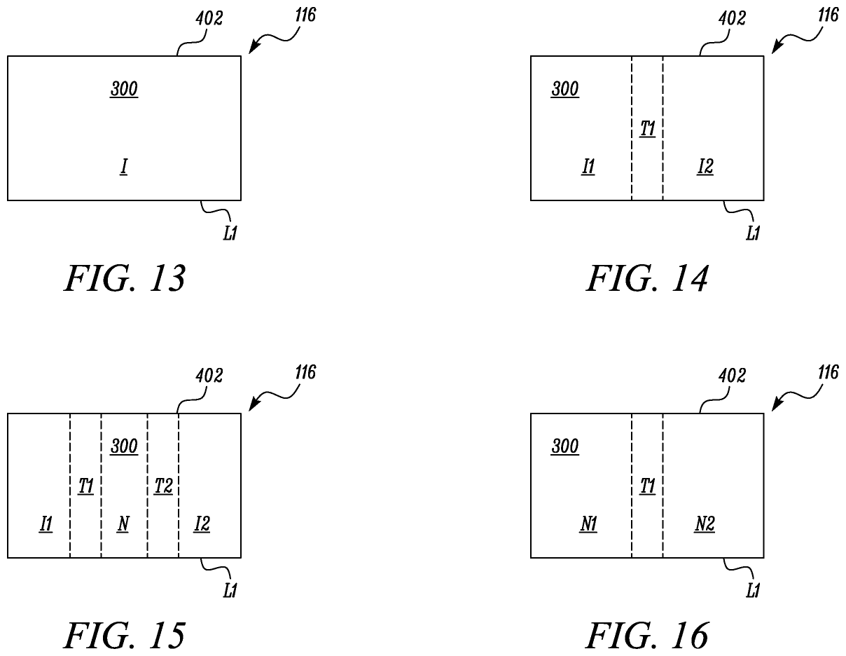

In accordance with an embodiment and referring to FIGS. 13-16, the flight 300 within a segment of the element 116, for example, segment 402 of the segments 402-410, may also transform from an integer lobe flight to another integer lobe flight, an integer lobe flight to a non-integer lobe flight, a non-integer lobe flight to an integer lobe flight and from a non-integer lobe flight to another non-integer lobe flight. Each segment having a constant lead.

In addition, the flight 300 in each segment, such as the segment 402, may also transform from an integer lobe flight to a non-integer lobe flight and back to an integer lobe flight. In addition, the flight 300 in each segment, such as the segment 402, may also transform from a non-integer lobe flight to an integer lobe flight and back to a non-integer lobe flight.

In addition, the flight 300 within each segment, such as the segment 402, may transform into a transition flight in between transformations from an integer lobe flight to a non-integer lobe flight or vice versa, or also from an integer lobe flight to another integer lobe flight or from a non-integer lobe flight to another non-integer lobe flight. The transition flight in each segment may have the same lead or a different lead from the lead of the segment.

For example, referring to FIG. 13, in one embodiment, the flight 300 in segment 402 may be an integer lobe flight I, such as a single lobe, bi-lobe, tri-lobe, or a four-lobe flight without any transformations.

Referring to FIG. 14, in another embodiment, the flight 300 in segment 402 may transform from a first integer lobe flight Il to a transition flight T1 and then transform to a second integer lobe flight I2. For example, the flight 300 may transform from a single lobe flight to tri-lobe flight within a segment.

Referring to FIG. 15, in another embodiment, the flight 300 may also transform from an integer lobe flight to a non-integer lobe flight and back to an integer lobe flight or may transform from a non-integer lobe flight to an integer lobe flight and then back to a non-integer lobe flight within a segment. For example, the integer lobe flight I1, such as a single lobe flight may transform to the transition flight T1 and then transform to the non-integer lobe flight N, such as fractional lobe 1.3.xx. The flight 300 may then transform from the non-integer lobe flight N to the transition flight T2 and then transform to a second integer lobe flight I2, for example, a tri-lobe flight.

Referring to FIG. 16, in another embodiment, the flight 300 in segment 402 may also transform from a first non-integer lobe flight N1 to a transition flight T1 and then transform to a second non-integer lobe flight N2. For example, the flight 300 in segment 402 may transform from a non-integer lobe flight 1.3.80 to 1.3.05.

Referring to FIGS. 13-16, in an embodiment, the lead of the transition flights T1 and/or T2 may be the same lead L1 as the segment 402. In another embodiment, the lead of the transition flights T1 and/or T2 may be a different lead, such as L2 or L3, from the lead L1 of the segment 402.

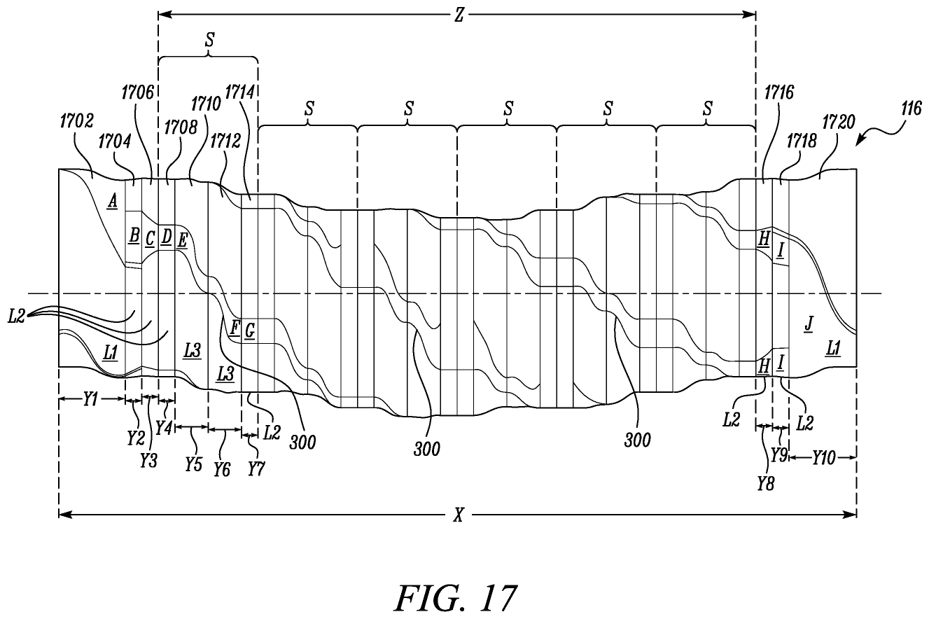

Referring to FIG. 17, the element 116 having multiple segments 1702-1720 in accordance with another embodiment is disclosed. The length X of the element 116 may 24 mm. The lengths Y1-Y10 of the segments 1702-1720 may be 2 mm, 0.5 mm, 0.5 mm, 0.5 mm, 1 mm, 1 mm, 0.5 mm, 0.5 mm, 0.5 mm, and 2 mm respectively. In an embodiment, the lengths Y1-Y10 of the segments 1702-1720 may be equal.

The flight 300 may have portions A—J extending along the segments 1702-1720 respectively. The flight 300 may have a different lead in two or more segments of the segments 1702-1720. For example, the portion A of the flight 300 may have lead L1, the portions B—D of the flight 300 may have a lead L2, and the portions E, F of the flight 300 may have a lead L3 respectively.

The flight 300 may have a different lead in two or more adjacent segments of the segments 1702-1720. For example, the flight 300 in segment 1702 may have the lead L1 and the flight 300 in segment 1704, adjacent to segment 1702, may have the lead L2. Similarly, the flight 300 in segment 1708 may have the lead L2 and the flight 300 in segment 1710, adjacent to segment 1708, may have the lead L3. In an embodiment, the flight 300 may have a same lead in two or more adjacent segments of the segments 1702-1720 respectively. For example, the flight 300 in the adjacent segments 1704-1708 may have the same lead L2 and the flight 300 in the adjacent segments 1710, 1712 may have the same lead L3.

In an embodiment, two or more segments of the segments 1702-1720 may form a group or a sequence that repeats itself as a group along the length X of the element 116. For example, a sequence S of segments 1708-1714 having the flight 300 with leads L2, L3, L3, and L2 respectively may be repeated multiple times along the length of the element 116. In an embodiment, the sequence S may be repeated until the segment 1716. In an embodiment, a total length Z of the repeating sequence S may vary in a range of 30 percent to 90 percent of the length X of the element 116, but not limited to the range specified herein. For example, for instances when the length X of the element 116 is 24 mm and the lengths of the segments 1708-1714 are 0.5 mm, 1 mm, 1 mm, and 0.5 mm respectively, a length of the sequence S may be equal to a sum of the lengths of the segments 1708-1714, that is, 2 mm. The sequence S of the segments 1708-1714 may be repeated six times along the length X of the element 116. Accordingly, the total length Z of the repeating sequence S may be 12 mm, that is 50 percent of the length X of 24 mm, of the element 116.

### Specific Embodiments are Described Below

An element for a co-rotating twin screw processor, the element having an axial bore for mounting on a screw shaft of the processor, the element comprising a continuous self-wiping flight helically formed thereon, the element comprising a plurality of segments, wherein the flight has a different lead in at least two segments of the plurality of segments.

Such element(s), wherein the flight has a different lead in two adjacent segments of the plurality of segments.

Such element(s), wherein the flight has a different lead in every segment of the plurality of segments.

Such element(s), wherein the flight is an integer lobe flight.

Such element(s), wherein the flight is a non-integer lobe flight.

Such element(s), wherein the flight is a fractional lobe flight.

Such element(s), wherein the flight has a different lead and a different non-integer lobe in two segments of the plurality of segments.

Such element(s), wherein the flight has a different lead and a different non-integer lobe in two segments of the plurality of segments.

Such element(s), wherein the flight has a different lead in adjacent segments of the plurality of segments and the flight transforms into a different non-integer lobe flight in adjacent segments of the plurality of segments.

Such element(s), wherein the flight has a different lead in two segments and is an integer lobe flight in one segment and a non-integer lobe flight in another.

Such element(s), wherein the flight transforms between at least two segments, the flight transformation involving a change in the lobes, wherein the change in the lobes includes a flight transformation from an integer lobe flight to a non-integer lobe flight or vice versa, or from an integer lobe flight to another integer lobe flight or from a non-integer lobe flight to another non-integer lobe flight.

Such element(s), wherein the flight first transforms into a transition flight before transforming into a different lobe flight.

Such element(s), wherein the flight has a different lead in adjacent segments of the plurality of segments and flight transforms from an integer lobe flight to a non-integer lobe flight in at least two adjacent segments.

Such element(s), wherein the flight transforms from a first integer lobe flight into a second integer lobe flight within a segment of the plurality of segments.

Such element(s), wherein the flight transforms from an integer lobe flight into a non-integer lobe flight or from a non-integer lobe flight to an integer lobe flight within a segment of the plurality of segments.

Such element(s), wherein the flight transforms from a first non-integer lobe flight into a second non-integer lobe flight within a segment of the plurality of segments.

Such element(s), wherein the flight transforms from an integer lobe flight into a non-integer lobe flight and back to an integer lobe flight or from a non-integer lobe flight to an integer lobe flight and back to a non-integer lobe flight within a segment of the plurality of segments.

Such element(s), wherein at least two segments may form a group of segments that repeats itself as a group along the length of the element.

Such element(s), wherein the group of segments repeats itself along 30 to percent of the length of the element.

Such element(s), wherein each of the segments is of equal length.

### INDUSTRIAL APPLICABILITY

The element 116 as taught by the disclosure is suitable for use in co-rotating twin screw extruders. The element 116 as taught may improve a melting capability of the processor 100 and may help in achieving a homogeneous melt mix. Further, the element 116 as taught also does not compromise on the self-wiping ability of the processor 100. In addition, the element 116 as taught may also improve an elongational flow of the materials during the melting and homogenizing process. Furthermore, the element 116 as taught may facilitate the melting and/or homogenizing of the materials at a process temperature lesser than generally involved in the melting and/or homogenizing process. In particular, the element 116 is suitable for processing of temperature sensitive materials such as pharmaceutical ingredients including API. The element 116 is also suitable for processing mixed materials with different melting or softening points such as waste material for recycling.

1. An element for a co-rotating twin screw processor, the element having an axial bore for mounting on a screw shaft of the processor, the element comprising a continuous self-wiping flight helically formed thereon, the element comprising a plurality of segments, wherein the flight has a different lead in at least two segments of the plurality of segments.

2. An element for a co-rotating twin screw processor as claimed in claim 1, wherein the flight has a different lead in two adjacent segments of the plurality of segments.

3. An element for a co-rotating twin screw processor as claimed in claim 1, wherein the flight has a different lead in every segment of the plurality of segments.

4. An element for a co-rotating twin screw processor as claimed in claim 1, wherein the flight is an integer lobe flight.

5. An element for a co-rotating twin screw processor as claimed in claim 1, wherein the flight is a non-integer lobe flight.

6. An element for a co-rotating twin screw processor as claimed in claim 5, wherein the flight is a fractional lobe flight.

7. An element for a co-rotating twin screw processor as claimed in claim 1, wherein the flight has a different lead and a different non-integer lobe in at least two segments of the plurality of segments.

8. An element for a co-rotating twin screw processor as claimed in claim 1, wherein the flight has a different lead and a different integer lobe in at least two segments of the plurality of segments.

9. An element for a co-rotating twin screw processor as claimed in claim 1, wherein the flight has a different lead in two segments and is an integer lobe flight in one segment and a non-integer lobe flight in the other.

10. An element for a co-rotating twin screw processor as claimed in claim 1, wherein the flight transforms between at least two segments, the flight transformation involving a change in the lobes, wherein the change in the lobes includes a flight transformation from an integer lobe flight to a non-integer lobe flight or vice versa, or from an integer lobe flight to another integer lobe flight or from a non-integer lobe flight to another non-integer lobe flight.

11. An element for a co-rotating twin screw processor as claimed in claim 10, wherein the flight first transforms into a transition flight before transforming into a different lobe flight.

12. An element for a co-rotating twin screw processor as claimed in claim 1, wherein the flight has a different lead in adjacent segments of the plurality of segments and flight transforms from an integer lobe flight to a non-integer lobe flight in at least two adjacent segments.

13. An element for a co-rotating twin screw processor as claimed in claim 1, wherein the flight transforms from a first integer lobe flight into a second integer lobe flight within a segment of the plurality of segments.

14. An element for a co-rotating twin screw processor as claimed in claim 1, wherein the flight transforms from an integer lobe flight into a non-integer lobe flight or from a non-integer lobe flight to an integer lobe flight within a segment of the plurality of segments.

15. An element for a co-rotating twin screw processor as claimed in claim 1, wherein the flight transforms from a first non-integer lobe flight into a second non-integer lobe flight within a segment of the plurality of segments.

16. An element for a co-rotating twin screw processor as claimed in claim 1, wherein the flight transforms from an integer lobe flight into a non-integer lobe flight and back to an integer lobe flight or from a non-integer lobe flight to an integer lobe flight and back to a non-integer lobe flight within a segment of the plurality of segments.

17. An element for a co-rotating twin screw processor as claimed in claim 1, wherein at least two segments may form a group of segments that repeats itself as a group along the length of the element.

18. An element for a co-rotating twin screw processor as claimed in claim 17, wherein the group of segments repeats itself along 30 to 90 percent of the length of the element.

19. An element for a co-rotating twin screw processor as claimed in claim 1, wherein each of the segments is of equal length.
